(19) United States
(12) Patent Application Publication
(10) Pub. No.: US 2008/0132695 A1
(43) Pub. Date: Jun. 5, 2008

(54) Cross-linked Polysaccharide Derivatives

(76) Inventors: Eric Francotte, Nuglar (CH); Tong Zhang, Strasbourg (FR)

Correspondence Address: Paul Paglierani;Novartis Institute for BioMedical Research, Inc., 400 Technology Square, Cambridge, MA, 02139, US

(21) Appl. No.: 12/031,179

(22) Filed: Feb. 14, 2008

Related U.S. Application Data
(63) Continuation-in-part of application No. 08/983,392, filed on Feb. 9, 1998, now abandoned.

(30) Foreign Application Priority Data
Jul. 21, 1995 (CH) 2160/95
Jun. 27, 1996 (CH) 1608/96

(51) Int. Cl. C08B 37/00; C08B 3/00; C08B 33/00

(52) U.S. Cl. 536/56; 536/123.1; 536/126

(57) ABSTRACT

The invention relates to substantially photochemically or thermally cross-linked polysaccharide derivatives in which the OH groups as OR groups have been esterified or converted into carbamate (urethane) or mixtures thereof and that do not contain photopolymerisable functional groups prior to the cross-linking. They can be used as carrier materials for the chromatographic separation of enantiomers.

### CROSS-REFERENCE

This application is a CIP of Ser. No. 08/983,392, Feb. 9, 1998, pending, which is a 371 of PCT/EP96/03145, Jul. 17, 1996 and a CIP of Ser. No. 09/202,600, Dec. 17, 1998, pending, which is a 371 of PCT/EP97/03,225, Jun. 20, 1997.

### BACKGROUND OF THE INVENTION

The invention relates to substantially photochemically or thermally cross-linked polysaccharide derivatives that do not contain photopolymerisable functional groups prior to the cross-linking, which can be used as carrier materials for the chromatographic separation of enantiomers.

K. Kimata et al. describe in Anal. Methods and Instrumentation, Vol 1, (1993) 23, the preparation of a chiral carrier material that is stable towards solvents and that is obtained by polymerisation of cellulose vinyl benzoate. The chemically bonded stationary phases, which consist of cellulose, are compared with non-polymerised analogous phases in respect of their chiral selectivity and stability towards solvents, there being observed an increase in the stability towards organic solvents and a slight decrease in the chiral selectivity of the chemically bonded cellulose.

C. Oliveros et al. describe in J. Liquid Chromatogr., 18, (1995) 1521, stationary phases consisting of 3,5-dimethylphenyl carbamate cellulose that have been immobilised on a carrier. The resulting chiral stationary phases can be immobilised, for example, on carriers (e.g., silica gel), and are then resistant to the customary solvents, the method of immobilisation employed in that work already having been known from the prior art (for example, U.S. Pat. No. 1,690,620).

DE-A-2 422 365 discloses polymers suitable for photopolymerisation that have anhydride-containing groups and that are converted by means of mechanically effective light into resistant substances that are suitable as protective printing compounds or for the preparation of protective printing templates for printing plates. No mention is made of their use as a carrier material for the chromatographic separation of enantiomers.

N. R. Bertoniere et al. describe in J. Appl. Polymer Sci., Vol 15, (1971) 1743, cotton fabrics containing cinnamic acid esters (cinnamoyl radicals) as substituents, which on being irradiated with light of a certain wavelength (2573A) first isomerise and then dimerise to form derivatives of truxillic and truxinic acid, but the photochemical reaction takes place essentially only on the surface of the fabric.

U.S. Pat. Nos. 2,682,481 and 2,682,482 disclose methods by which soluble carbohydrates, especially cellulose derivatives, that carry unsaturated functional groups can be converted by heating with peroxide catalysts and by dimerisation or further cross-linking into shaped articles having an insoluble surface.

H. Engelmann et al describe in a publication issued by the Staatliches Forschungsinstitut für makromolekulare Chemie, Freiburg i. Breisgau, (1957), 233, a method of preparing cellulose tricrotonate and cellulose acetocrotonates and the reaction of those products in cross-linking with oxygen or light and the addition of halogens and diamines. It is pointed out that all the products obtained, including those having a very low crotonyl content, are then insoluble in organic solvents. There is no indication of suitability as a carrier material for the chromatographic separation of enantiomers.

In Journal of Chromatograhy A, 728 (1996), pp 407-414, stationary phases are prepared from polysaccharide derivatives by crosslinking 10-undecenoyl side chains with allyl silica, the selectivity of these phases in most cases being reduced by introducing the 10-undecenoyl side chains.

FR-A-2 714 671 also describes stationary phases of polysaccharide derivatives which must necessarily contain unsaturated side chains, for example a 10-undecenoyl side chain, so that a suitable immobilization can take place. In this case too, a multi-step synthesis must be carried out before immobilization, in order to introduce the 10-undecenoyl group, but consistent results can only be obtained with difficulty and the selectivity of the stationary phase is reduced in most cases.

In the publications cited above, the starting materials used contain polymerisable groups for the cross-linking, that is to say the cross-linking is effected by polymerisation of one or more double bonds.

### SUMMARY OF THE INVENTION

The present invention relates to photochemically or thermally cross-linked polysaccharide derivatives in which the OH groups as OR groups have been esterified or converted into carbamate (urethane) or mixtures thereof, with the proviso that the OR groups do not contain polymerisable double bonds prior to the cross-linking.

### DETAILED DESCRIPTION

The invention relates especially to photochemically or thermally cross-linked polysaccharide derivatives in which the OH groups as OR groups have been converted into an unsubstituted or substituted aryl, arylalkyl, hetaryl or heterarylalkyl ester or into an unsubstituted or substituted aryl, arylalkyl, hetaryl or hetarylalkyl carbamate (urethane) or mixtures thereof, with the proviso that the OR groups do not contain polymerisable double bonds prior to the cross-linking.

Special importance is attached to cross-linked polysaccharide derivatives in which the OH groups as OR groups have been converted into an unsubstituted or substituted aryl or arylalkyl ester or into an unsubstituted or substituted aryl or arylalkyl carbamate or mixtures thereof, with the proviso that the OR groups do not contain polymerisable double bonds prior to the cross-linking.

Also of special importance are cross-linked cellulose or amylose derivatives in which the OH groups as OR groups have been converted into an aryl or arylalkyl ester or aryl or arylalkyl carbamate, the ester or carbamate being unsubstituted or mono- or poly-substituted by lower alkyl and/or by halogen, or mixtures thereof, with the proviso that the OR groups do not contain polymerisable double bonds prior to the cross-linking.

Very special importance is attached to cross-linked cellulose or amylose derivatives in which the OH groups as OR groups have been converted into a phenyl or benzyl ester or phenyl or benzyl carbamate, the ester or carbamate being unsubstituted or mono- or poly-substituted by lower alkyl and/or by halogen, or mixtures thereof, with the proviso that the OR groups do not contain polymerisable double bonds.

When the OH groups, as OR groups, are esterified or subjected to carbamate conversion, the hydrogen of the OH group is replaced by an acyl radical of the formula R′—C(═O)— or by the acyl radical of carbamic acid R′—NH—C(═O)—, it not having been necessary for all OH groups to have been converted into the corresponding OR groups.

Lower radicals and compounds herein are to be understood as being, for example, those having up to and including 7, preferably up to and including 4, carbon atoms (C atoms).

Polysaccharides are, for example, cellulose, amylose, chitosan, dextrin, xylan, amylopectin, curdlan, chitin and insulin, which are obtainable as polysaccharides in a high degree of purity. Preference is given to the use of polysaccharides having a degree of polymerisation (number of pyranose and furanose rings) of at least the number 5, and especially preferably of at least the number 10, in order to ensure ease of handling.

Lower alkyl is, for example, C₁-C₄alkyl, such as methyl, ethyl, propyl or butyl, which may be unsubstituted or substituted by halogen, such as fluorine or chlorine, for example trifluoromethyl or trichloromethyl.

Aryl as such is, for example, phenyl or naphthyl, such as 1- or 2-naphthyl, or substituted phenyl or naphthyl, for example phenyl or naphthyl substituted by lower alkyl halo-lower alkyl hydroxy, lower alkoxy, lower alkanoyloxy, halogen, and/or by cyano.

Aryl is preferably phenyl that is unsubstituted or substituted as indicated above, and is especially phenyl.

Arylalkyl is preferably aryl-lower alkyl especially phenyl-lower alkyl more especially phenylethyl or benzyl.

Lower alkoxy is, for example, n-propoxy, isopropoxy, n-butoxy or tert-butoxy, preferably ethoxy and especially methoxy.

Lower alkanoyloxy is, for example, propionyloxy or pivaloyloxy, preferably acetyloxy.

Halogen is, for example, chlorine or fluorine, and also bromine and iodine.

Halo-lower alkyl is, for example, 2- or 3-halo-lower alkyl for example 2-halopropyl, 3-halopropyl or 3-halo-2-methyl-propyl.

Hetaryl is to be understood as being especially a monocyclic but also a bi- or poly-cyclic radical of aromatic character. Bi- and poly-cyclic hetaryl may be composed of a number of heterocyclic rings or preferably of a heterocycle and one or more, for example one or two but especially one, fused carbocyclic ring, especially a benzo ring. Each individual ring contains, for example, 3, 5, 6, 7 and especially 5 or 6 ring members. Hetaryl is especially an aza-, thia-, oxa-, thiaza-, thiadiaza-, oxaza-, diaza-, or tetraza-cyclic radical.

Hetaryl is especially a monocyclic monoaza-, monothia-, or monooxa-cyclic radical, such as pyrryl (e.g., 2-pyrryl or 3-pyrryl), pyridyl (e.g., 2-, 3-, or 4-pyridyl), thienyl (e.g., 2- or 3-thienyl), or furyl (e.g., 2-furyl); a bicyclic monoaza-, monooxa-, or monothia-cyclic radical, such as indolyl (e.g., 2- or 3-indolyl), quinolinyl (e.g., 2- or 4-quinolinyl), isoquinolinyl (e.g., 1-isoquinolinyl), benzofuran (e.g., 2- or 3-benzofuranyl), or benzothienyl (e.g., 2- or 3-benzothienyl); a monocyclic diaza-, triaza-, tetraza-, oxazathiaza-, or thiadiaza-cyclic radical, such as imidazolyl (e.g., 2-imidazolyl), pyrimidinyl (e.g., 2- or 4-pyrimidinyl), triazolyl (e.g., 1,2,4-triazol-3-yl), tetrazolyl (e.g., 1- or 5-tetrazolyl), oxazolyl (e.g., 2-oxazolyl), isooxazolyl (e.g., 3- or 4-isoxazolyl), thiazolyl (e.g., 2-thiazolyl), isothiazolyl (e.g., 3- or 4-isothiazolyl), or 1,2,4- or 1,3,4-thiadiazolyl (e.g., 1,2,4-thiadiazol-3-yl or 1,3,4-thiadiazol-2-yl); or a bicyclic diaza-, oxaza-, or thiaza-cyclic radical, such as benzimidazolyl (e.g., 2-benzimidazolyl), benzoxazolyl (e.g., 2-benzoxazolyl), or benzthiazolyl (e.g., 2-benzthiazolyl).

Hetaryl radicals are unsubstituted or carry substituents. Suitable substituents at ring carbon atoms are, for example, the substituents indicated above for aryl radicals and in addition oxo (═O). Ring nitrogen atoms can be substituted by, for example, lower alkyl, aryl-lower alkyl, lower alkanoyl, benzyl, carboxy, lower alkoxycarbonyl, hydroxy, lower alkoxy, lower alkanoyloxy, or oxido (—O). Hetaryl is especially pyridyl, thienyl, pyrryl, or furyl.

Hetarylalkyl radicals are composed of the above-mentioned hetaryl radicals and the aforementioned alkyl radicals, especially lower alkyl radicals. Hetaryl-lower alkyl is especially pyridyl-, thienyl-, pyrryl-, or furyl-methyl.

The compounds of the invention may be prepared in two ways.

Polysaccharide derivatives in which the OH groups as OR groups have been esterified or converted into carbamate, after previously being coated onto a carrier or after previous conditioning as pure material using an emulsion, are cross-linked by means of (hv)-irradiation to form the compounds according to the invention.

The cross-linking can be effected by supplying radiation energy of various wavelengths, for example by means of laser beams or preferably by irradiation using a conventional submersible mercury discharge lamp. Suitable suspension agents for the irradiation are, for example, inert solvents, such as hydrocarbons such as hexane or lower alkanols, such as methanol, ethanol, propanol or isopropanol or aqueous mixtures thereof, ethereal solvents, for example diethyl ether, or carbon tetrachloride or acetonitrile.

The photochemical cross-linking can be carried out optionally in the presence of photosensitisers, for example in the presence of thioxanthone.

As carriers (also known in the art as supports) it is possible to use silicon dioxides, for example silica gel or modified silica gel, especially aminosilanised silica gel, glass and also aluminium oxides (alumina), graphite or zirconium oxide (zirconia).

The compounds of the invention are also prepared by subjecting polysaccharide derivatives in which the OH groups as OR groups have been esterified or converted into a carbamate to thermal cross-linking after they have previously been coated onto a support, or after previous conditioning as a pure material.

The cellulose derivatives can be thermally immobilized by a variety of processes:

a) On the one hand, the thermal treatment can be effected after applying a coating of the cellulose derivative, for example after coating the cellulose derivative onto a support, for example macroporous silica gel, in the presence of a free-radical initiator, for example α,α′-azoisobutyronitrile (AIBN).

b) In another process, the cellulose derivative is coated onto a support, for example macroporous silica gel, and the coated silica gel is further coated with an AIBN solution before carrying out the thermal treatment.

c) In a further process, compounds of the invention can be prepared by subjecting polysaccharides which have previously been conditioned as pure material, for example as beads or membranes, to thermal crosslinking using a free-radical initiator, for example AIBN, to give the compounds of the invention.

The thermal treatment is effected by heating the coated support material, or the conditioned pure material, to 50-150°, but preferably to 100-120°.

The polysaccharides used as starting compounds in which the OH groups as OR groups have been esterified or converted into carbamate (urethane) are prepared by esterifying the free OH groups of the polysaccharide compounds or converting them into carbamate (urethane).

The esterification and carbamate formation are carried out in a manner known per se by reaction with an isocyanate or with a reactive functional carboxylic acid derivative.

For example, esterification can be effected with unsubstituted or substituted benzoyl halides, especially benzoyl chlorides, the corresponding carboxylic acid anhydrides or alternatively with a mixture of the corresponding carboxylic acid and a suitable dehydrating agent.

For the esterification it is possible to use any inert solvent that does not impede the esterification, it being usual also to add a catalyst, for example a tertiary amine, such as 4-(N,N-di-methylamino)pyridine.

The carbamate formation is usually carried out by reaction with a suitable isocyanate in the presence of a suitable catalyst. As catalyst it is possible to use a Lewis base, for example a tertiary amine, or alternatively a Lewis acid, for example a tin compound, for example dibutyltin dilaurate.

The reaction is preferably carried out in the presence of a tertiary base, for example in the presence of pyridine or quinoline, which act simultaneously as solvent, but it is preferable to use as tertiary base also 4-(N,N-dimethylamino)pyridine which is a reaction accelerator.

For the conversion of the OH groups into the corresponding OR groups by esterification or carbamate formation, there are used, especially, unsubstituted or substituted benzoyl chlorides or phenyl isocyanates.

Chloro- or methyl-substituted phenyl isocyanates or benzoyl chlorides are preferably used, it being possible for the methyl groups and chlorine atoms to be arranged in the meta- or ortho-positions relative to one another.

The photochemically cross-linked polysaccharide derivatives according to the invention are used as chiral carriers for the chromatographic separation of enantiomers.

Surprisingly, by means of the process according to the invention it is possible to immobilise polysaccharide derivatives having no photopolymerisable functional groups, a high degree of stability towards solvents being achieved. Surprisingly the high separation ability is fully retained after the immobilisation.

The immobilisation allows the use of mobile phases that contain, for example, methylene chloride, tetrahydrofuran, chloroform, dioxane or ethyl acetate and that would dissolve non-immobilised polysaccharide derivatives.

The use of such mobile phases gives rise to better results in the enantiomeric separation of a large number of racemates and also allows the dissolution of sparingly soluble samples.

The cross-linked polysaccharides according to the invention in conditioned form can also be used as pure polymer for the chromatographic separation of enantiomers.

A further possible application is the use of cross-linked polysaccharide derivatives in the production of coatings on various materials, such as wood, paper, plastics, and metals. The said coatings can also be photo-structured.

The cross-linked polysaccharides according to the invention can also be used as a material for the production of various membranes for any type of application.

The various chromatographic enantiomeric separations are described and explained in more detail after the preparative section (Examples).

The following Examples (including the preparation of the starting materials and intermediates) are given for the purposes of illustration and better understanding of the invention. Temperatures are given in degrees Celsius and (unless otherwise indicated) pressures are given in bar.

### Photo-Chemically Cross-Linked Polysaccharides

### EXAMPLE 1

1.53 g of cellulose tribenzoate (prepared in accordance with known procedures: Chirality, 3 (1991) 43) are dissolved in 60 ml of methylene chloride. 4 g of aminosilanised silica (prepared in accordance with a known method from Nucleosil-4000, particle size 10 μm, Macherey-Nagel) are suspended in that solution. The suspension is then concentrated in a rotary evaporator and dried under a high vacuum.

### Immobilisation

5 g of the coated material are suspended in a mixture of 100 ml of methanol and 400 ml of water and stirred. The suspension is irradiated for 20 hours with a submersible mercury discharge lamp (Philips, HPK-125 Watt, quartz casing). The suspension is filtered and the filter cake is washed with methanol and dried. In order to remove the non-immobilised material, the irradiated product is then extracted with methylene chloride in a Soxhlet apparatus for 16 hours. The insoluble residue is suspended in about 30 ml of methylene chloride and stirred for about 30 minutes. 300 ml of hexane are then added (rate of addition: 1 ml/min). The product is isolated by filtration and washed with hexane.

Elementary analysis: C, 6.20%.

### EXAMPLE 2

Analogously to Example 1, 4.0 g of aminosilanised silica are coated with 1.53 g of cellulose tris(4-methylbenzoate) (prepared in accordance with known procedures: J. Chromatogr., 595 (1992) 63). The photochemical immobilisation of the cellulose derivative is carried out analogously to Example 1 in a mixture of 100 ml of methanol and 300 ml of water. The removal of the non-immobilised material by extraction with methylene chloride and the reconditioning by treatment with hexane are also carried out analogously.

Elementary analysis: C, 16.97%.

### EXAMPLE 3

3.0 g of cellulose tris(4-methylbenzoate) beads (prepared in accordance with known procedures: J. Chromatogr., 595 (1992) 63) are suspended in a mixture of 100 ml of methanol and 400 ml of water and stirred. The suspension is irradiated for 20 hours with a submersible mercury discharge lamp (Philips, HPK-125 Watt, quartz casing). The suspension is filtered and the filter cake is washed with methanol and dried. The solid material is then extracted with methylene chloride in a Soxhlet apparatus for 16 hours. The insoluble residue is suspended in about 30 ml of methylene chloride and stirred for about 30 minutes. 300 ml of hexane are then added (rate of addition: 1 ml/min). The product is isolated by filtration and washed with hexane.

### EXAMPLE 4

Analogously to Example 1, 4.0 g of aminosilanised silica are coated with 1.53 g of cellulose tris-(3-methylbenzoate) (prepared in accordance with known procedures: J. Chromatogr., 595 (1992) 63). The photochemical immobilisation of the cellulose derivative is carried out analogously to Example 1 in a mixture of 150 ml of methanol and 300 ml of water. The removal of the non-immobilised material by extraction with methylene chloride and the reconditioning by treatment with hexane are also carried out analogously.

Elementary analysis: C, 15.83%.

### EXAMPLE 5

Analogously to Example 1, 4.0 g of aminosilanised silica are coated with 1.53 g of cellulose tris(2-methylbenzoate) (prepared in accordance with known procedures: J. Chromatogr., 595 (1992) 63). The photochemical immobilisation of the cellulose derivative is carried out analogously to Example 1 in a mixture of 100 ml of methanol and 400 ml of water. The removal of the non-immobilised material by extraction with methylene chloride and the reconditioning by treatment with hexane are also carried out analogously.

Elementary analysis: C, 11.66%.

### EXAMPLE 6

Analogously to Example 1, 4.0 g of aminosilanised silica are coated with 1.53 g of cellulose tris(4-ethylbenzoate) (prepared in accordance with known procedures: J. Chromatogr., 595 (1992) 63). The photochemical immobilisation of the cellulose derivative is carried out analogously to Example 1 in a mixture of 200 ml of methanol and 300 ml of water. The removal of the non-immobilised material by extraction with methylene chloride and the reconditioning by treatment with hexane are also carried out analogously.

Elementary analysis: C, 19.24%.

### EXAMPLE 7

Analogously to Example 1, 4.0 g of aminosilanised silica are coated with 1.53 g of cellulose tris(4-tert-butylbenzoate) (prepared in accordance with known procedures: J. Chromatogr., 595 (1992) 63). The photochemical immobilisation of the cellulose derivative is carried out analogously to Example 1 in a mixture of 100 ml of methanol and 400 ml of water. The removal of the non-immobilised material by extraction with methylene chloride and the reconditioning by treatment with hexane are also carried out analogously.

Elementary analysis: C, 4.41%.

### EXAMPLE 8

Analogously to Example 1, 4.0 g of aminosilanised silica are coated with 1.53 g of cellulose tris(4-fluorobenzoate) (prepared in accordance with known procedures: J. Chromatogr., 595 (1992) 63). The photochemical immobilisation of the cellulose derivative is carried out analogously to Example 1 in a mixture of 150 ml of methanol and 250 ml of water. The removal of the non-immobilised material by extraction with methylene chloride and the reconditioning by treatment with hexane are also carried out analogously.

### EXAMPLE 9

Analogously to Example 1, 4.0 g of aminosilanised silica are coated with 1.53 g of cellulose tris(2,5-dichlorobenzoate) (prepared in accordance with known procedures: J. Chromatogr., 595 (1992) 63). The photochemical immobilisation of the cellulose derivative is carried out analogously to Example 1 in a mixture of 150 ml of methanol and 250 ml of water. The removal of the non-immobilised material by extraction with methylene chloride and the reconditioning by treatment with hexane are also carried out analogously.

Elementary analysis: C, 12.38%; Cl, 7.73%.

### EXAMPLE 10

2.4 g of cellulose tris(phenylcarbamate) (prepared in accordance with known procedures: J. Chromatogr., 363 (1986) 173) are dissolved in 36 ml of tetrahydrofuran. The resulting solution is divided into three portions. 5.5 g of aminosilanised silica (Nucleosil-4000, particle size 10 μm, Macherey-Nagel) are in succession mixed with the three portions and then concentrated in a rotary evaporator. After drying in vacuo, 7.5 g of product are isolated.

### Immobilisation:

5.0 g of that material are suspended in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 4.9 g. That product is extracted with tetrahydrofuran in a Soxhlet apparatus for 17 hours. The insoluble residue is suspended in about 30 ml of tetrahydrofuran, and 300 ml of hexane are added (rate of addition: 1.2 ml/min). The product is isolated by filtration and washed with hexane (3.4 g).

### EXAMPLE 11

1.2 g of cellulose tris(phenylcarbamate) (prepared in accordance with known procedures: J. Chromatogr., 363 (1986) 173) are dissolved in 18 ml of tetrahydrofuran. The resulting solution is divided into three portions. 2.75 g of aminosilanised silica (Nucleosil-4000, particle size 10 μm, Macherey-Nagel) are in succession mixed with the three portions and then concentrated in a rotary evaporator. After drying in vacuo, 3.7 g of product are isolated.

### Immobilisation:

3.7 g of that material are suspended together with 37 mg of thioxanthone in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 3.62 g. That product is extracted with tetrahydrofuran in a Soxhlet apparatus for 17 hours. The insoluble residue is suspended in about 30 ml of tetrahydrofuran, and 300 ml of hexane are added (rate of addition: 1.2 ml/min). The product is isolated by filtration and washed with hexane. Yield: 3.2 g.

Elementary analysis: C, 15.53%; H, 1.26%; N, 1.89%.

### EXAMPLE 12

1 g of cellulose tris(3,5-dimethylphenylcarbamate) (prepared in accordance with known procedures: J. Chromatogr., 363 (1986) 173) are dissolved in 13.9 ml of tetrahydrofuran. The resulting solution is divided into three portions. 2.3 g of aminosilanised silica (Nucleosil-4000, particle size 7 μm, Macherey-Nagel) are in succession mixed with the three portions and then concentrated in a rotary evaporator. After drying in vacuo, 3.1 g of product are isolated.

### Immobilisation:

3.1 g of that material are suspended in 250 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 3.03 g. That product is extracted with tetrahydrofuran in a Soxhlet apparatus for 17 hours. The insoluble residue is suspended in about 30 ml of tetrahydrofuran, and 300 ml of hexane are added (rate of addition: 1.2 ml/min). The product is isolated by filtration and washed with hexane (2.6 g).

Elementary analysis: C, 13.64%; H, 1.27%; N, 1.43%.

### EXAMPLE 13

7.5 g of cellulose tris(3,5-dimethylphenylcarbamate) beads (prepared in accordance with a known procedure) are suspended together with 150 mg of thioxanthone in 300 ml of hexane (isomeric mixture) and stirred. The suspension is irradiated for 24 hours with a submersible mercury discharge lamp (Philips, HPK-125 Watt, quartz casing). The suspension is filtered and the filter cake is washed with isopropanol and hexane and dried. The solid material is then extracted with tetrahydrofuran in a Soxhlet apparatus for 16 hours. The insoluble residue is suspended in about 70 ml of tetrahydrofuran and stirred for about 30 minutes. 500 ml of hexane are then added (rate of addition: 1 ml/min). The product is isolated by filtration and washed with hexane.

### EXAMPLE 14

2.83 g of cellulose tris(4-methylphenylcarbamate) (prepared in accordance with known procedures: J. Chromatogr., 363 (1986) 173) are dissolved in 50 ml of tetrahydrofuran. The resulting solution is divided into three portions. 8.5 g of aminosilanised silica (Nucleosil-4000, particle size 10 μm, Macherey-Nagel) are in succession mixed with the three portions and then concentrated in a rotary evaporator. After drying in vacuo, 1.1 g of product are isolated.

### Immobilisation A:

4.0 g of that material are suspended in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 3.93 g. That product is extracted with tetrahydrofuran in a Soxhlet apparatus for 22 hours. The insoluble residue is suspended in about 30 ml of tetrahydrofuran, and 300 ml of hexane are added (rate of addition: 1.2 ml/min). The product is isolated by filtration and washed with hexane (3.50 g).

### Immobilisation B:

4.0 g of that material are suspended together with 40 mg of thioxanthone in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 3.9 g. That product is extracted with tetrahydrofuran in a Soxhlet apparatus for 24 hours. The insoluble residue is suspended in about 30 ml of tetrahydrofuran, and 300 ml of hexane are added (rate of addition: 1.2 ml/min). The product is isolated by filtration and washed with hexane. Yield: 3.8 g.

Elementary analysis: C, 14.75%; H, 1.31%; N, 1.56%.

### EXAMPLE 15

3.3 g of cellulose tris(4-chlorophenylcarbamate) (prepared in accordance with known procedures: J. Chromatogr., 363 (1986) 173) are dissolved in 50 ml of tetrahydrofuran. The resulting solution is divided into three portions. 7.7 g of aminosilanised silica (Nucleosil-4000, particle size 10 μm, Macherey-Nagel) are in succession mixed with the three portions and then concentrated in a rotary evaporator. After drying in vacuo, 10.6 g of product are isolated.

### Immobilisation A:

4.0 g of that material are suspended in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 3.89 g. That product is extracted with tetrahydrofuran in a Soxhlet apparatus for 18 hours. The insoluble residue is suspended in about 30 ml of tetrahydrofuran, and 300 ml of hexane are added (rate of addition: 1.2 ml/min). The product is isolated by filtration and washed with hexane (3.6 g).

### Immobilisation B:

4.0 g of that material are suspended together with 40 mg of thioxanthone in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 3.8 g. That product is extracted with tetrahydrofuran in a Soxhlet apparatus for 20 hours. The insoluble residue is suspended in about 30 ml of tetrahydrofuran, and 300 ml of hexane are added (rate of addition: 1.2 ml/min). The product is isolated by filtration and washed with hexane. Yield: 3.2 g.

Elementary analysis: C, 9.88%; N, 1.18%; Cl, 2.90%.

### EXAMPLE 16

2.3 g of cellulose tris(3-chloro-4-methylphenylcarbamate) (prepared in accordance with known procedures: J. Chromatogr., 363 (1986) 173) are dissolved in 48 ml of tetrahydrofuran. The resulting solution is divided into three portions. 8.1 g of aminosilanised silica (Nucleosil-4000, particle size 10 μm, Macherey-Nagel) are in succession mixed with the three portions and then concentrated in a rotary evaporator. After drying in vacuo, 10.1 g of product are isolated.

### Immobilisation A:

3.9 g of that material are suspended in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 3.65 g. That product is extracted with tetrahydrofuran in a Soxhlet apparatus for 17 hours. The insoluble residue is suspended in about 30 ml of tetrahydrofuran, and 300 ml of hexane are added (rate of addition: 1.2 ml/min). The product is isolated by filtration and washed with hexane (3.4 g).

### Immobilisation B:

3.6 g of that material are suspended together with 36 mg of thioxanthone in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 3.41 g. That product is extracted with tetrahydrofuran in a Soxhlet apparatus for 17 hours. The insoluble residue is suspended in about 30 ml of tetrahydrofuran, and 300 ml of hexane are added (rate of addition: 1.2 ml/min). The product is isolated by filtration and washed with hexane. Yield: 3.3 g.

Elementary analysis: C, 11.95%; N, 1.26%; Cl 3.12%.

### EXAMPLE 17

1.2 g of amylose tris(3,5-dimethylphenylcarbamate) (prepared in accordance with known procedures: Chem. Lett. 1987, 1857) are dissolved in a mixture of 15 ml of tetrahydrofuran and 15 ml of methylene chloride. The resulting solution is divided in three portions. 3.6 g of aminosilanised silica (Nucleosil-4000, particle size 10 μm, Macherey-Nagel) are in succession mixed with the three portions and then concentrated in a rotary evaporator. After drying in vacuo, 4.4 g of product are isolated.

### Immobilisation:

4.1 g of that material are suspended together with 41 mg of thioxanthone in 300 ml of hexane (isomeric mixture) and stirred. The suspension is irradiated for 24 hours with a submersible mercury discharge lamp (Philips, HPK-125 Watt, quartz casing). The precipitate is filtered off, washed with hexane and dried. Yield: 4.1 g. That product is extracted in a Soxhlet apparatus with methylene chloride for 17 hours and then with tetrahydrofuran for 22 hours. The insoluble residue is suspended in about 30 ml of tetrahydrofuran, and 300 ml of hexane are added (rate of addition: 1.2 ml/min). The product is isolated by filtration and washed with hexane. Yield: 3.8 g.

Elementary analysis: C, 13.01; H, 1.26; N, 1.34

### Column Packing:

2.5 g of the material obtained are made into a slurry in 25 ml of hexane/2-propanol (90:10, % by vol.) or in chloroform/heptane (50:50, % by vol.) and using the slurry method introduced into a steel column (25 cm×0.4 cm) at a pressure of 100 bar.

### EXAMPLE 18

2 g of amylose (mol. wt. ˜150 000, Serva) are dried at 130° C. for 6 hours in a round-bottomed flask while being flushed through with nitrogen. There are then added in the given order at room temperature: 25 ml of pyridine, 0.1 ml of dibutyltin laurate and 10 ml of (S)-1-phenylethyl isocyanate. The suspension is boiled at reflux (bath temperature 130° C.) for 72 hours. After cooling the solution at 60° C., 50 ml of methanol are added and the resulting suspension is poured into 300 ml of methanol. The suspension is filtered and washed with methanol. The solid residue is dissolved in 120 ml of methylene chloride. The resulting solution is filtered and precipitated in 500 ml of methanol. The precipitate is filtered off and washed with methanol. The filter cake is again dissolved in 120 ml of methylene chloride and precipitated with 500 ml of ethanol. The precipitate is filtered off, washed with ethanol and dried under a high vacuum at 60° C. Yield: 4 g.

Elementary analysis: calc. C, 65.66; H, 6.18; N, 6.96. found C, 64.74; H, 6.28; N, 6.77.

2 g of amylose tris((S)-1-phenylethylcarbamate) are dissolved in a mixture of 30 ml of tetrahydrofuran and 30 ml of methylene chloride. The resulting solution is divided into three portions. 6.6 g of aminosilanised silica (Nucleosil-4000, particle size 7 mm, Macherey-Nagel) are in succession mixed with the three portions and then concentrated in a rotary evaporator. After drying in vacuo, 8.3 g of product are isolated.

### Immobilisation:

3.2 g of that material are suspended together with 32 mg of thioxanthone in a mixture of methanol/water (175 ml each) and stirred (400 rev/min). The suspension is irradiated for 21 hours with a submersible mercury discharge lamp (Philips, HPK-125 Watt, quartz casing). The precipitate is filtered off, washed with 100 ml of ethanol and dried. Yield: 3.28 g. That product is extracted with tetrahydrofuran in a Soxhlet apparatus for 15 hours. The insoluble residue is suspended in about 30 ml of tetrahydrofuran, and 300 ml of hexane are added (rate of addition: 1.6 ml/min). The product is isolated by filtration and washed with hexane. Yield: 3.1 g (76.9% immobilisation).

### Testing of the Chiral Stationary Phases:

The phases from Examples 2, 4, 6, 11, 12, 14-17 are tested with various racemic structures and with various mobile phases (see Tables).

HPLC chromatography is carried out using a Shimadzu LC-6A system with a flow rate of 0.7 ml/min. and at room temperature. Detection is effected by means of UV spectroscopy and polarimetry (Perkin Elmer 241 LC). The separation factor α is determined as the measurement value.

$$α = \frac{{k}_{2}^{′}}{{k}_{1}^{′}} = \frac{{t}_{2} - {t}_{o}}{{t}_{1} - {t}_{0}}$$

where k′₂ and k′₁ are the respective capacity factors of the second and first eluted enantiomers and t₂ and t₁ are the retention times thereof. t₀ is the elution time of tri-tert-butylbenzene (non-retained compound).

### Separation Factor in Chromatographic Separations Using the Product of Example 2

| | | heptane/ |
|---|---|---|
| | hexane/ | chloro- |
| | 2-propanol | form |
| Mobile phase | 9:1 | 6:4 |
| 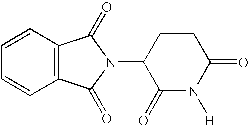 | insoluble | 1.21 |
| 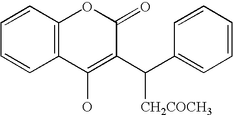 | — | 1.59 |
| 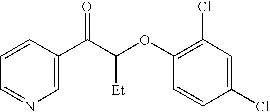 | 2.11 | 1.28 |
| 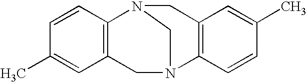 | 6.43 | 1.40 |
| 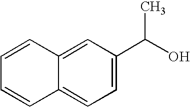 | 1.29 | 1.19 |
| 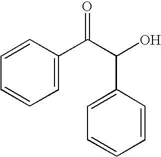 | 1.28 | 1.0 |
| 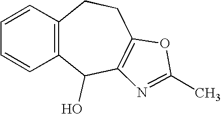 | 1.37 | 1.0 |
| 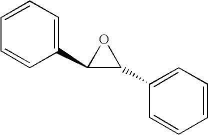 | 1.37 | 1.0 |
| 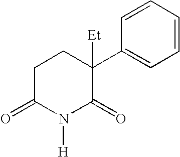 | 1.72 | 1.51 |
| 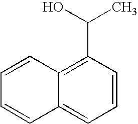 | 1.59 | 1.57 |

### Separation Factor in Chromatographic Separations Using the Product of Example 4

| | heptane/ | heptane/ | heptane/ | | | |
|---|---|---|---|---|---|---|
| | chloroform/ | chloroform/ | chloroform/ | heptane/ | chloroform/ | hexane/ |
| | ethanol | ethanol | ethanol | chloroform | heptane | 2-propanol |
| Mobile phase | 60:40:3 | 65:35:1 | 75:25:0.5 | 75:25 | 9:1 | 9:1 |
| 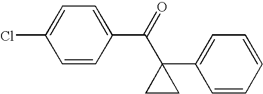 | — | — | 1.0 | — | 1.38 | 1.25 |
| 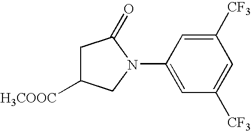 | 1.0 | 1.08 | 1.15 | 1.19 | 1.16 | 1.17 |
| 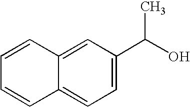 | 1.18 | 1.22 | 1.24 | 1.23 | 1.23 | 1.41 |
| 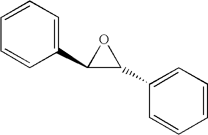 | 1.38 | 1.55 | 1.96 | 1.89 | 2.05 | 2.12 |
| 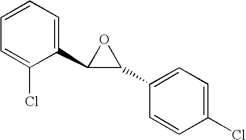 | 1.0 | 1.0 | 1.36 | 1.30 | 1.53 | 1.54 |
| 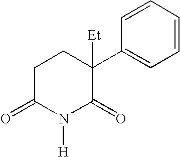 | 1.37 | 1.38 | 1.42 | 1.39 | | 1.39 |
| 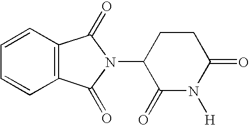 | 1.24 | 1.22 | | | insoluble | insoluble |
| 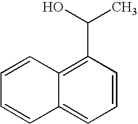 | 1.49 | 1.60 | 1.72 | 1.71 | 1.71 | 1.56 |

### Separation Factor in Chromatographic Separations Using the Product of Example 6

| | heptane/ |
|---|---|
| | chloroform/ |
| | ethanol |
| Mobile phase | 60:40:3 |
| 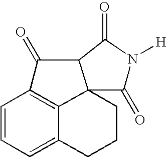 | 1.45 |
| 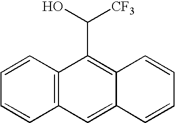 | 1.0 |
| 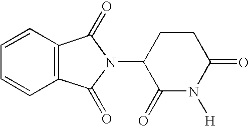 | 1.29 |
| 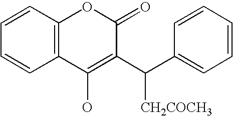 | 1.45 |

### Separation Factor in Chromatographic Separations Using the Product of Example 9

| | heptane/ |
|---|---|
| | chloroform |
| Mobile phase | 70:30 |
| 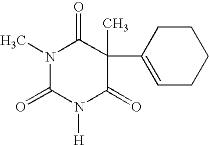 | 1.13 |
| 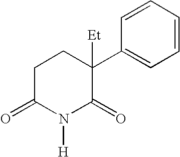 | 1.17 |
| 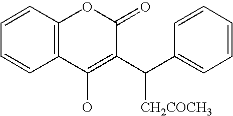 | 1.43 |

### Separation Factor in Chromatographic Separations Using the Product of Example 11

| | hexane/ | chloroform/ |
|---|---|---|
| | 2-propanol | heptane |
| Mobile phase | 9:1 | 1:1 |
| 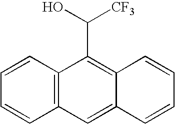 | 1.46 | 1.50 |
| 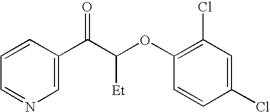 | 1.27 | 1.0 |
| 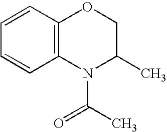 | 1.45 | 2.06 |
| 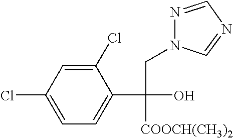 | 1.0 | 1.24 |
| 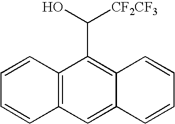 | 2.00 | 2.22 |
| 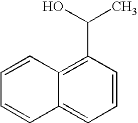 | 1.18 | 1.24 |

### Separation Factor in Chromatographic Separations Using the Product of Example 12

| | | | heptane/ |
|---|---|---|---|
| | hexane/ | chloroform/ | THF/ |
| | 2-propanol | heptane | 2-propanol |
| Mobile phase | 9:1 | 1:1 | 85:15:1 |
| 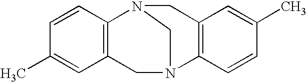 | 1.46 | 1.48 | 1.67 |
| 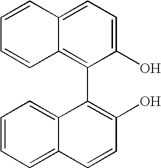 | 1.15 | 1.40 | 1.00 |
| 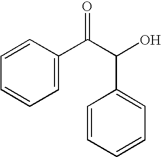 | 1.40 | 1.23 | 1.30 |
| 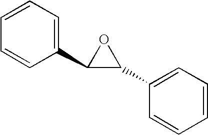 | 1.52 | 1.51 | 1.00 |
| 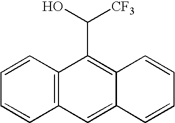 | 2.56 | 2.96 | 2.11 |
| 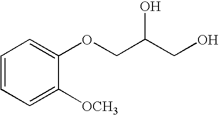 | 2.38 | 2.09 | 1.90 |
| 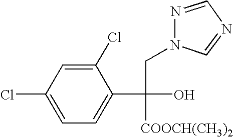 | 1.40 | 1.63 | 1.55 |
| 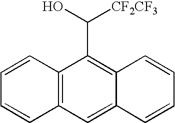 | 2.76 | 6.45 | 2.04 |
| 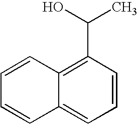 | 1.62 | 1.34 | 1.66 |

### Separation Factor in Chromatographic Separations Using the Product of Example 14

| | Immobilisation method | | |
|---|---|---|---|
| | A | B | B |
| | hexane/ | hexane/ | chloroform/ |
| | 2-propanol | 2-propanol | heptane |
| Mobile phase | 9:1 | 9:1 | 1:1 |
| 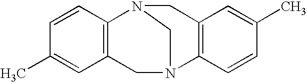 | 1.40 | 1.21 | 1.0 |
| 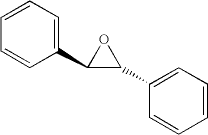 | 1.45 | 1.37 | 1.0 |
| 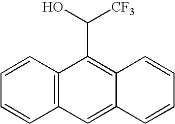 | 1.52 | 1.49 | 1.58 |
| 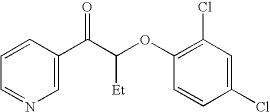 | 1.42 | 1.35 | 1.0 |
| 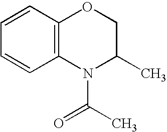 | 1.22 | 1.31 | 1.39 |
| 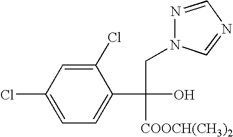 | 1.37 | 1.23 | 1.36 |
| 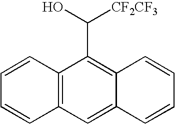 | 2.39 | 2.11 | 2.48 |
| 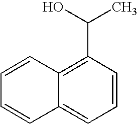 | 1.22 | 1.21 | 1.23 |

### Separation Factor in Chromatographic Separations Using the Product of Example 15

| | Immobilisation method | | | |
|---|---|---|---|---|
| | A | A | B | B |
| | hexane/ | chloroform/ | hexane/ | chloroform/ |
| | 2-propanol | heptane | 2-propanol | heptane |
| Mobile phase | 9:1 | 1:1 | 9:1 | 1:1 |
| 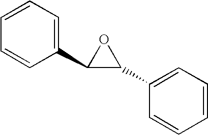 | 1.64 | 1.39 | 1.49 | 1.0 |
| 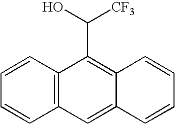 | 1.39 | 1.30 | 1.0 | 1.20 |
| 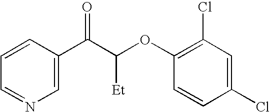 | 1.44 | 1.45 | 1.31 | 1.29 |
| 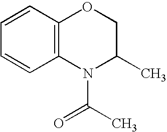 | 1.24 | 1.74 | 1.19 | 1.87 |
| 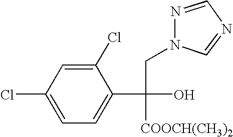 | 1.0 | 1.32 | 1.0 | 1.18 |
| 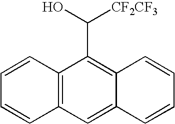 | 1.74 | 2.03 | 1.0 | 1.43 |

### Separation Factor in Chromatographic Separations Using the Product of Example 16

| | Immobilisation method | | | |
|---|---|---|---|---|
| | A | A | B | B |
| | hexane/ | chloroform/ | hexane/ | chloroform/ |
| | 2-propanol | heptane | 2-propanol | heptane |
| Mobile phase | 9:1 | 1:1 | 9:1 | 1:1 |
| 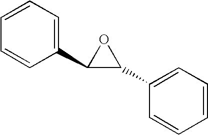 | 1.79 | 1.86 | 1.51 | 1.0 |
| 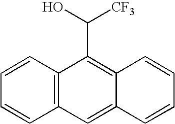 | 1.36 | 1.42 | 1.29 | 1.42 |
| 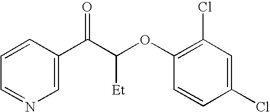 | 1.31 | 1.24 | 1.25 | 1.18 |
| 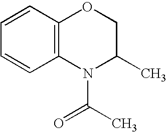 | 1.09 | 1.16 | 1.08 | 1.43 |
| 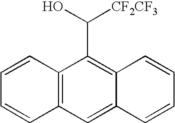 | 1.47 | 1.91 | 1.54 | 2.02 |
| 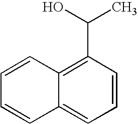 | 1.22 | 1.18 | 1.16 | 1.15 |

### Separation Factor in Chromatographic Separations Using the Product of Example 17

| | | | hexane/ |
|---|---|---|---|
| | | | dichloro- |
| | hexane/ | chloroform/ | methane/ |
| | 2-propanol | heptane | 2-propanol |
| Mobile phase | 9:1 | 1:1 | 80:20:2.5 |
| 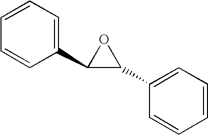 | 1.61 | 1.0 | 1.20 |
| 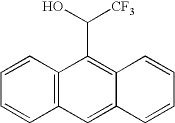 | 1.0 | 1.29 | 1.20 |
| 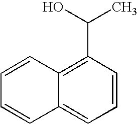 | 1.45 | 2.19 | 1.73 |

Separation factor in chromatographic separations using the product of Example 18

| | | heptane/ | |
|---|---|---|---|
| | hexane/ | chloroform/ | heptane/ |
| | 2-propanol | 2-propanol | chloroform |
| Mobile phase | 9:1 | 75:25:1 | 1:1 |
| 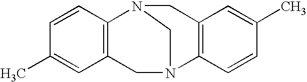 | 1.85 | 1.62 | 1.57 |
| 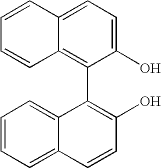 | 1.19 | 1.23 | 1.23 |
| 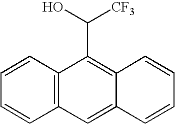 | 1.40 | 1.59 | 1.54 |
| 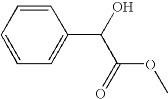 | 1.10 | 1.31 | 1.39 |
| 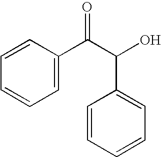 | 1.50 | 1.54 | 1.56 |
| 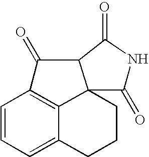 | 1.86 | 2.01 | 2.00 |
| 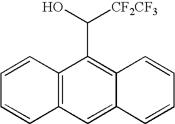 | 2.21 | 2.56 | 2.47 |
| 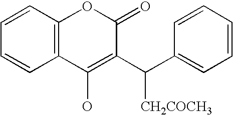 | 2.93 | 3.87 | 3.85 |

### Thermally Cross-Linked Polysaccharides

### EXAMPLE 19

1.6 g of cellulose Tris(4-methylbenzoate) (preparation following a known protocol: J. Chromatogr., 595 (1992) 63) together with 1.6 g of α,α′-azoisobutyronitrile (AIBN) are dissolved in 60 ml of methylene chloride. 3.5 g of amino-silanized silica (prepared following a known method from Nucleosil-4000, particle size 10 μm, Macherey-Nagel) are suspended in this solution. This suspension is subsequently concentrated on a Rotavapor and dried in a high vacuum.

Yield 6.7 g.

The resulting powder is heated in the dry state in a round-bottom flask at 120° C. for 6 hours under nitrogen. The product is suspended in 150 ml of methanol and the suspension is stirred for 1 hour. The suspension is subsequently filtered and the residue is washed with methanol and dried. Yield 5.03 g. To remove non-immobilized material, the product is extracted for 17 hours in a Soxhlet using methylene chloride. The insoluble residue is suspended in approximately 30 ml of methylene chloride and the suspension is stirred for about 30 minutes. Then, 300 ml of hexane are added (rate of addition: 1.6 ml/min). The product is filtered off and washed with hexane.

Yield 3.7 g.

Elemental analysis: C, 8.18; H, 0.80.

### EXAMPLE 20

1.42 g of cellulose Tris(phenylcarbamate) (preparation following a known protocol: J. Chromatogr., 363 (1986) 173) together with 1.42 g of AIBN are dissolved in a mixture of 10 ml of methylene chloride and 30 ml of tetrahydrofuran. 3.25 g of amino-silanized silica (Nucleosil-4000, particle size 7 μm, Macherey-Nagel) are suspended in this solution. The suspension is homogenized for 1 hour at room temperature in an ultrasonic bath and subsequently concentrated on a Rotavapor. The resulting powder is heated in the dry state in a round-bottom flask at 120° C. for 7 hours under nitrogen. The product is suspended in 150 ml of methanol and the suspension is stirred for 1 hour. The suspension is subsequently filtered and the residue is washed with methanol and dried.

Yield 4.5 g.

To remove non-immobilized material, the product is extracted with tetrahydrofuran for 17 hours in a Soxhlet. After drying in vacuo, 3.58 g are isolated. The insoluble residue is suspended in approximately 30 ml of tetrahydrofuran and the suspension is stirred for approximately 30 minutes. Then, 300 ml of hexane are added (rate of addition: 1.6 ml/min). The product is filtered off and washed with hexane.

Yield 3.5 g.

Elemental analysis: C, 9.75; H, 0.88.

### EXAMPLE 21

1 g of cellulose Tris(3,5-dimethylphenylcarbamate) (preparation following a known protocol: J. Chromatogr., 363 (1986) 173) together with 1 g of AIBN are dissolved in 25 ml of tetrahydrofuran. This solution is divided into three parts. 3 g of amino-silanized silica (Nucleosil-4000, particle size 7 μm, Macherey-Nagel) are mixed in succession with the three parts and in each case subsequently evaporated on a Rotavapor at 30° C. 4 g are isolated after drying in vacuo.

The powder is heated in the dry state in a round-bottom flask for 15 hours at 120° C. under nitrogen. The product is suspended in 100 ml of methanol and stirred for 1 hour. The suspension is then filtered and the residue is washed with methanol and dried. Yield 3.94 g. To remove non-immobilized material, the product is extracted for 17 hours in a Soxhlet with tetrahydrofuran. The insoluble residue is suspended in approximately 30 ml of tetrahydrofuran, and 300 ml of hexane are added (rate of addition: 1.6 ml/min). The product is filtered off and washed with hexane (3.2 g).

Elemental analysis: C, 7.63; H, 0.81; N, 0.89.

### EXAMPLE 22

3.5 g of amino-silanized silica (Nucleosil-4000, particle size 7 μm, Macherey-Nagel) coated with 25% by weight of cellulose Tris(3,5-dimethylphenylcarbamate) (preparation following a known protocol: J. Chromatogr., 363 (1986) 173) are suspended in a solution of 525 mg of AIBN in 15 ml of methanol. This suspension is subsequently evaporated on a Rotavapor and dried in a high vacuum.

The powder is heated in the dry state in a round-bottom flask at 120° C. for 14 hours under nitrogen. The product is suspended in 80 ml of methanol and stirred for ½ hours. The suspension is subsequently filtered and the product is washed with ethanol and dried. Yield 3.33 g. To remove non-immobilized material, the product is extracted for 17 hours in a Soxhlet with tetrahydrofuran. The insoluble residue is suspended in approximately 30 ml of tetrahydrofuran, and 300 ml of hexane are added (rate of addition: 1.6 ml/min). The product is filtered off and washed with hexane (2.6 g).

Elemental analysis: C, 7.78; H, 0.85; N, 1.00.

### Column Packing:

2.5 g of the resulting material are suspended in 25 ml of hexane/ethanol (90:10, vol %), and this was used to pack a steel column (25 cm×0.4 cm) by the slurry method, at a pressure of 100 bar.

### Test of the Chiral Stationary Phases:

The phases of Examples 19-22 were tested using a variety of racemic structures and a variety of mobile phases (see the tables).

HPLC chromatography was carried out by means of a Shimadzu LC-6A system at a flow rate of 0.7 ml/min. and at room temperature. Detection was effected by UV spectroscopy and polarimetry (Perkin Elmer 241 LC). The measured value was the separation factor α.

$$α = \frac{{k}_{2}^{′}}{{k}_{1}^{′}} = \frac{{t}_{2} - {t}_{o}}{{t}_{1} - {t}_{0}}$$

where k′₂ and k′₁ are the capacity factors of the second and first enantiomers which are eluted, and t₂ and t₁ are their retention times. t₀ is the elution time of tri-tert-butylbenzene (non-retained compound)

### Separation Factor in Chromatographic Separations Using the Product of Example 19

| | Hexane/ | | Heptane/ | | Heptane/ | |
|---|---|---|---|---|---|---|
| | 2-propanol | | chloroform | | chloroform | |
| | 9:1 | | 9:1 | | 75:25 | |
| Mobile phase | k′₁ | α | k′₁ | α | k′₁ | α |
| 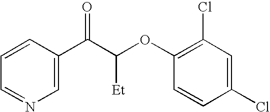 | 1.40 | 2.06 | 1.14 | 2.07 | 0.23 | 1.00 |
| 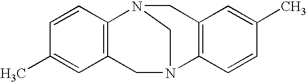 | 0.59 | 6.91 | 0.33 | 3.96 | 0.12 | 1.00 |
| 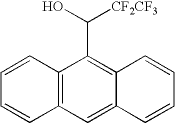 | 0.70 | 1.27 | 5.22 | 1.73 | 1.25 | 1.50 |
| 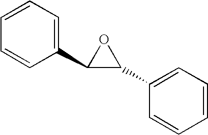 | 0.63 | 1.35 | 0.46 | 1.00 | 0.13 | 1.00 |
| 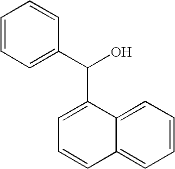 | 2.88 | 1.00 | 7.11 | 1.18 | 1.31 | 1.16 |
| 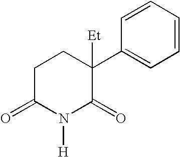 | 2.42 | 1.70 | 5.35 | 1.89 | 0.82 | 1.67 |
| 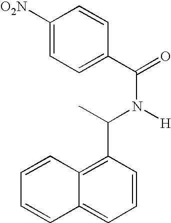 | insoluble | insoluble | insoluble | insoluble | 3.12 | 1.27 |
| 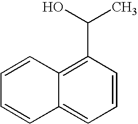 | 1.10 | 1.55 | 3.36 | 1.96 | 0.85 | 1.71 |

### Separation Factor in Chromatographic Separations Using the Product of Example 20

| | Hexane/ | | Heptane/ | |
|---|---|---|---|---|
| | 2-propanol | | chloroform | |
| | 9:1 | | 1:1 | |
| Mobile phase | k′₁ | α | k′₁ | α |
| 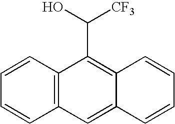 | 0.75 | 1.47 | 1.17 | 1.22 |
| 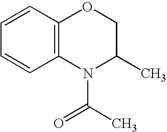 | 1.82 | 1.87 | 0.18 | 2.18 |
| 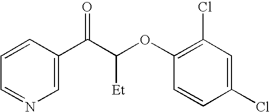 | 1.56 | 1.36 | 0.26 | 1.00 |
| 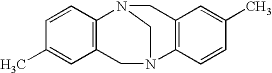 | 0.52 | 1.31 | 0.06 | 1.00 |
| 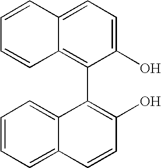 | 2.79 | 1.11 | 0.95 | 1.40 |
| 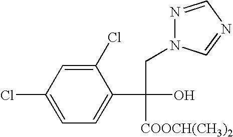 | 2.44 | 1.28 | 1.38 | 1.40 |
| 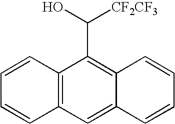 | 0.28 | 2.03 | 0.53 | 1.69 |
| 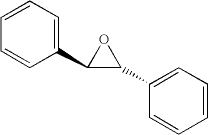 | 0.33 | 1.34 | 0.07 | 1.00 |
| 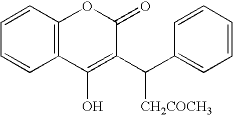 | — | — | 3.08 | 1.81 |
| 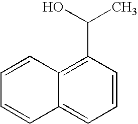 | 0.79 | 1.26 | 0.65 | 1.00 |

### Separation Factor in Chromatographic Separations Using the Product of Example 21

| | Hexane/ | | Heptane/ | |
|---|---|---|---|---|
| | 2-propanol | | chloroform | |
| | 9:1 | | 1:1 | |
| Mobile phase | k′₁ | α | k′₁ | α |
| 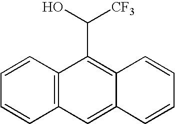 | 1.22 | 2.88 | 1.83 | 3.78 |
| 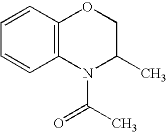 | 0.86 | 1.65 | 0.15 | 1.00 |
| 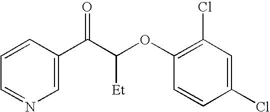 | 0.79 | 3.43 | 0.16 | 1.00 |
| 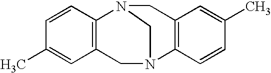 | 0.59 | 1.24 | 0.96 | 1.00 |
| 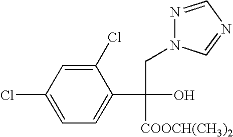 | 1.28 | 1.43 | 1.27 | 1.78 |
| 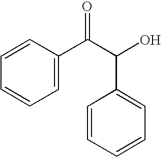 | 1.31 | 1.56 | 0.26 | 1.47 |
| 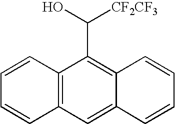 | 0.75 | 3.39 | 1.12 | 11.03 |
| 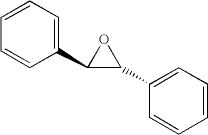 | 0.42 | 2.17 | 0.13 | 2.57 |
| 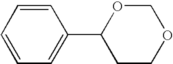 | 0.45 | 1.83 | 0.13 | 1.61 |
| 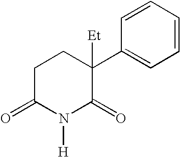 | 2.41 | 1.23 | 0.61 | 1.31 |
| 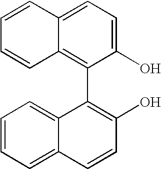 | 2.84 | 1.00 | 1.06 | 1.39 |
| 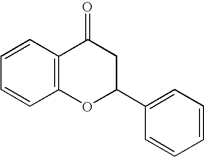 | 0.79 | 1.44 | 0.14 | 1.00 |
| 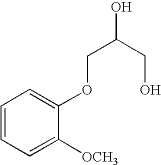 | 3.04 | 3.01 | 2.44 | 3.10 |
| 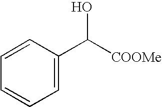 | 0.80 | 1.96 | 0.30 | 1.59 |
| 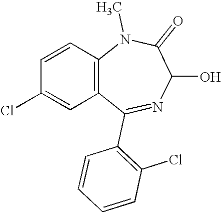 | 6.16 | 1.31 | 0.52 | 1.70 |
| 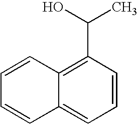 | 1.02 | 1.78 | 0.75 | 1.38 |

### Separation Factor in Chromatographic Separations Using the Product of Example 22

| | Hexane/ | | Heptane/ | |
|---|---|---|---|---|
| | 2-propanol | | chloroform | |
| | 9:1 | | 1:1 | |
| Mobile phase | k′₁ | α | k′₁ | α |
| 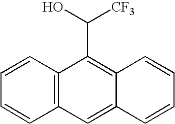 | 1.28 | 2.83 | 2.00 | 3.36 |
| 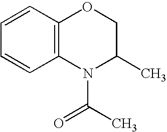 | 0.94 | 1.56 | 0.17 | 1.0 |
| 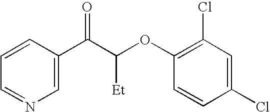 | 0.88 | 1.35 | 0.18 | 1.0 |
| 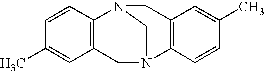 | 0.62 | 1.24 | 0.11 | 1.0 |
| 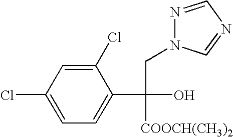 | 1.41 | 1.40 | 1.40 | 1.87 |
| 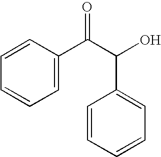 | 1.43 | 1.54 | 0.29 | 1.41 |
| 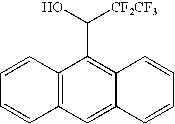 | 0.80 | 3.49 | 1.17 | 9.30 |
| 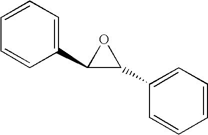 | 0.44 | 2.09 | 0.14 | 2.19 |
| 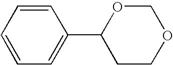 | 0.48 | 1.73 | 0.14 | 1.57 |
| 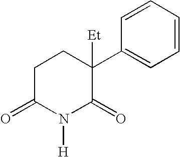 | 2.55 | 1.23 | 0.69 | 1.30 |
| 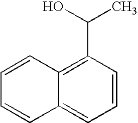 | 1.07 | 1.72 | 0.84 | 1.34 |

What is claimed is:

1. A photochemically or thermally cross-linked polysaccharide derivative in which the OH groups as OR groups have been esterified or converted into carbamate (urethane) or mixtures thereof, with the proviso that the OR groups do not contain polymerisable double bonds prior to the cross-linking.

2. A photochemically cross-linked polysaccharide derivative of claim 1 in which the OH groups as OR groups have been converted into an unsubstituted or substituted aryl, arylalkyl, hetaryl or heterarylalkyl ester or into an unsubstituted or substituted aryl, arylalkyl, hetaryl or hetarylalkyl carbamate (urethane) or mixtures thereof.

3. A photochemically cross-linked polysaccharide derivative of claim 1 in which the OH groups as OR groups have been converted into an unsubstituted or substituted aryl or arylalkyl ester or into an unsubstituted or substituted aryl or arylalkyl carbamate or mixtures thereof.

4. A photochemically cross-linked cellulose or amylose derivative of claim 1 in which the OH groups as OR groups have been converted into an aryl or arylalkyl ester or aryl or arylalkyl carbamate, the ester or carbamate being unsubstituted or mono- or poly-substituted by lower alkyl and/or by halogen, or mixtures thereof.

5. A photochemically cross-linked cellulose or amylose derivative of claim 1 in which the OH groups as OR groups have been converted into a phenyl or benzyl ester or phenyl or benzyl carbamate, the ester or carbamate being unsubstituted or mono- or poly-substituted by lower alkyl and/or by halogen, or mixtures thereof.

6. A process wherein a polysaccharide derivative in which the OH groups as OR groups have been esterified or converted into carbamate (urethane), after previously being coated onto a carrier or after previous conditioning as pure material using an emulsion, is cross-linked by means of (hv)-irradiation to form a photochemically cross-linked polysaccharide derivative of claim 1.

7. A process of claim 6, wherein a polysaccharide derivative in which the OH groups as OR groups have been converted into an unsubstituted or substituted aryl, arylalkyl, hetaryl or hetarylalkyl ester or into an unsubstituted or substituted aryl, arylalkyl, hetaryl or hetarylalkyl carbamate, after previously being coated onto a carrier or after previous conditioning as pure material using an emulsion, is cross-linked by means of (hv)-irradiation.

8. A process of claim 6, wherein a polysaccharide derivative in which the OH groups as OR groups have been converted into an unsubstituted or substituted aryl or arylalkyl ester or into an unsubstituted or substituted aryl or arylalkyl carbamate, after previously being coated onto a carrier or after previous conditioning as pure material using an emulsion, is cross-linked by means of (hv)-irradiation.

9. A process of claim 6, wherein a cellulose or amylose derivative in which the OH groups as OR groups have been converted into an aryl or arylalkyl ester that is unsubstituted or mono- or poly-substituted by lower alkyl and/or by halogen or into an aryl or arylalkyl carbamate that is unsubstituted or mono- or poly-substituted by lower alkyl and/or by halogen, after previously being coated onto a carrier or after previous conditioning as pure material using an emulsion, is cross-linked by means of (hv)-irradiation.

10. A process of claim 6, wherein a cellulose or amylose derivative in which the OH groups as OR groups have been converted into a phenyl or benzyl ester that is unsubstituted or mono- or poly-substituted by lower alkyl and/or by halogen or into a phenyl or benzyl carbamate that is unsubstituted or mono- or poly-substituted by lower alkyl and/or by halogen, after previously being coated onto a carrier or after previous conditioning as pure material using an emulsion, is cross-linked by means of (hv)-irradiation.

11. A process of claim 6, wherein the cross-linking is effected by irradiation by means of a submersible mercury discharge lamp.

12. A process of claim 6, wherein the cross-linking is effected by irradiation by means of a laser lamp.

13. A process of claim 6, wherein the cross-linking is effected in the presence of a photosensitiser.

14. A process of claim 6, wherein the carrier for the coating is silica gel, modified silica gel, aluminium oxide (alumina), glass, graphite, or zirconium oxide.

15. A process of claim 6, wherein an inert solvent is used for the preparation of a suspension.

16. The use of a photochemically cross-linked polysaccharide derivative of claim 1 as a stationary phase in chromatographic procedures, especially for the separation of enantiomers.

17. The use of a photochemically cross-linked polysaccharide derivative of claim 6 as a material for the preparation of membranes for various types of application.

18. The use of a photochemically cross-linked polysaccharide derivative of claim 6 in the preparation of coatings on various materials, for example, wood, paper, plastics, and metals.

19. A thermally cross-linked polysaccharide derivative of claim 1 in which the OH groups, as OR groups, have been converted into a substituted or unsubstituted aryl, arylalkyl, hetaryl, or hetarylalkyl ester or into an aryl-, arylalkyl-, hetaryl- or hetarylalkylcarbamate (urethane) or mixtures of these.

20. A thermally cross-linked polysaccharide derivative of claim 1 in which the OH groups, as OR groups, have been converted into a substituted or unsubstituted aryl or arylalkyl ester or into a substituted or unsubstituted aryl or arylalkylcarbamate or mixtures of these.

21. A thermally crosslinked cellulose or amylose derivative of claim 1 in which the OH groups, as OR groups, have been converted into an aryl- or arylalkyl ester or aryl or arylalkylcarbamate, unsubstituted or mono- or polysubstituted by lower alkyl and/or halogen, or mixtures of these.

22. A thermally crosslinked cellulose or amylose derivative of claim 1 in which the OH groups, as OR groups, have been converted into a phenyl or benzyl ester or phenyl- or benzylcarbamate, unsubstituted or mono- or polysubstituted by lower alkyl and/or halogen, or mixtures of these.

23. A process for the preparation of a crosslinked polysaccharide derivative of claim 1, which comprises subjecting a polysaccharide derivative in which the OH groups, as OR groups, has been esterified or converted into a carbamate (urethane) to thermal cross-linking
a) after previously coating the cellulose derivative onto a support in the presence of a free-radical initiator, or
b) after coating the cellulose derivative onto a support and further coating the support with a solution of a free-radical initiator, or
c) after previously conditioning the cellulose derivative as pure material in the presence of a free-radical initiator.

24. A process of claim 23, wherein a polysaccharide derivative in which the OH groups, as OR groups, have been converted into an unsubstituted or substituted aryl, arylalkyl, hetaryl or hetarylalkyl ester or into an unsubstituted or substituted aryl-, arylalkyl-, hetaryl- or hetarylalkylcarbamate is subjected to thermal cross linking
a) after previously coating the cellulose derivative onto a support in the presence of a free-radical initiator, or
b) after coating the cellulose derivative onto a support and further coating the support with a solution of a free-radical initiator, or
c) after previously conditioning the cellulose derivative as pure material in the presence of a free-radical initiator.

25. A process of claim 23, wherein a polysaccharide derivative in which the OH groups, as OR groups, have been converted into an unsubstituted or substituted aryl or arylalkyl ester or into an unsubstituted aryl- or arylalkylcarbamate, is subjected to thermal cross-linking
a) after previously coating the cellulose derivative onto a support in the presence of a free-radical initiator, or
b) after coating the cellulose derivative onto a support and further coating the support with a solution of a free-radical initiator, or
c) after previously conditioning the cellulose derivative as pure material in the presence of a free-radical initiator.

26. A process of claim 23, wherein a cellulose or amylose derivative in which the OH groups, as OR groups, have been converted into an aryl or arylalkyl ester which is unsubstituted or mono- or polysubstituted by lower alkyl and/or halogen or into an aryl- or arylalkylcarbamate which is unsubstituted or mono- or polysubstituted by lower alkyl and/or halogen is subjected to thermal crosslinking
a) after previously coating the cellulose derivative onto a support in the presence of a free-radical initiator, or
b) after coating the cellulose derivative onto a support and further coating the support with a solution of a free-radical initiator, or
c) after previously conditioning the cellulose derivative as pure material in the presence of a free-radical initiator.

27. A process of claim 23, wherein a cellulose or amylose derivative in which the OH groups, as OR groups, have been converted into a phenyl or benzyl ester which is unsubstituted or mono- or polysubstituted by lower alkyl and/or halogen or into a phenyl- or benzylcarbamate which is unsubstituted or mono- or polysubstituted by lower alkyl and/or halogen is subjected to thermal cross-linking
a) after previously coating the cellulose derivative onto a support in the presence of a free-radical initiator, or
b) after coating the cellulose derivative onto a support and further coating the support with a solution of a free-radical initiator, or
c) after previously conditioning the cellulose derivative as pure material in the presence of a free-radical initiator.

28. A process of claim 23, wherein cross-linking is effected thermally by heating to 50-150°.

29. A process of claim 23, wherein cross-linking is effected thermally by heating to 100-120°.

30. A process of claim 23, wherein the free-radical initiator used is α,α′-azoisobutyronitrile (AIBN).

31. A process of claim 23, wherein the support for the coating is a silica gel, modified silica gel, aluminium oxide (alumina), glass, graphite, or zirconium oxide.

32. A process of claim 23, wherein the support for the coating is macroporous silica gel.

33. The use of a thermally cross-linked polysaccharide derivative of claim 19 as a stationary phase in chromatographic methods, in particular for the separation of enantiomers.

34. The use of a thermally cross-linked polysaccharide derivative of claim 19 as a material for the preparation of membranes for various uses.

35. The use of a thermally cross-linked polysaccharide derivative of claim 19 for the preparation of coatings of various materials, e.g. wood, paper, polymers, and metals.
